(19) United States
(12) Patent Application Publication
(10) Pub. No.: US 2026/0002956 A1
(43) Pub. Date: Jan. 1, 2026

(54) Inertial Measurement Device

(71) Applicant: SEIKO EPSON CORPORATION, Tokyo (JP)

(72) Inventors: Yasushi YOSHIKAWA, Chino (JP); Kenta SATO, Shiojiri (JP)

(21) Appl. No.: 19/252,417

(22) Filed: Jun. 27, 2025

(30) Foreign Application Priority Data
Jun. 28, 2024 (JP) 2024-104908

(51) Int. Cl. G01P 15/09

(52) U.S. Cl. CPC G01P 15/09

(57) ABSTRACT

An inertial measurement device includes: a substrate; a container configured to house the substrate; a first fixation member and a second fixation member configured to fix the substrate to the container; a first sensor disposed at the substrate and configured to detect a physical quantity along an orthogonal axis to the substrate; and a second sensor disposed at the substrate, wherein the first sensor, the first fixation member and the second fixation member, and the second sensor are arranged in this order in a first direction parallel to the substrate, the second sensor detects a physical quantity along a second axis orthogonal to the first axis, and is separated from the first sensor by an area between the first fixation member and the second fixation member when viewed in a direction along the orthogonal axis.

The present application is based on, and claims priority from JP Application Serial Number 2024-104908, filed Jun. 28, 2024, the disclosure of which is hereby incorporated by reference herein in its entirety.

### BACKGROUND

### 1. Technical Field

The present disclosure relates to an inertial measurement device.

### 2. Related Art

An inertial measurement device including a plurality of inertial sensors is known. In the inertial measurement device described in JP-A-2023-175166, the plurality of inertial sensors is arranged on a substrate. In this case, the plurality of inertial sensors is apt to be affected by each other's vibration.

JP-A-2023-175166 is an example of the related art.

In the plurality of inertial sensors arranged on the same substrate, in order to reduce the influence of vibration on each other it is necessary to perform pairing of making the frequency difference of a natural frequency outside the measurement band with respect to all the inertial sensors on the substrate.

### SUMMARY

An inertial measurement device according to the present disclosure includes: a substrate; a container configured to house the substrate; a first fixation member and a second fixation member each configured to fix the substrate to the container; a first sensor disposed at the substrate and configured to detect a physical quantity along an orthogonal axis to the substrate; and a second sensor disposed at the substrate, wherein the first sensor, the first fixation member and the second fixation member, and the second sensor are arranged in this order in a first direction along a first axis parallel to the substrate, the second sensor detects a physical quantity along a second axis parallel to the substrate and orthogonal to the first axis, and the second sensor is separated from the first sensor by an area between the first fixation member and the second fixation member when viewed in a direction along the orthogonal axis.

### BRIEF DESCRIPTION OF THE DRAWINGS

FIG. 1 is a diagram showing an external configuration of an inertial measurement device.

FIG. 2 is a diagram showing an exploded perspective view of the inertial measurement device.

FIG. 3 is a diagram showing a schematic configuration of the inertial measurement device.

FIG. 4 is a diagram showing a schematic configuration of a container.

FIG. 5 is a diagram showing a schematic configuration of a circuit board.

FIG. 6 is a diagram showing a schematic configuration of an inertial sensor.

FIG. 7 is a diagram showing a schematic configuration of a sensor element.

FIG. 8 is a diagram showing an example of a configuration of a circuit board.

FIG. 9 is a diagram showing an example of the configuration of the circuit board.

FIG. 10 is a diagram showing an example of the configuration of the circuit board.

FIG. 11 is a diagram showing an example of the configuration of the circuit board.

FIG. 12 is a diagram showing an example of the configuration of the circuit board.

FIG. 13 is a diagram showing an example of the configuration of the circuit board.

### DESCRIPTION OF EMBODIMENTS

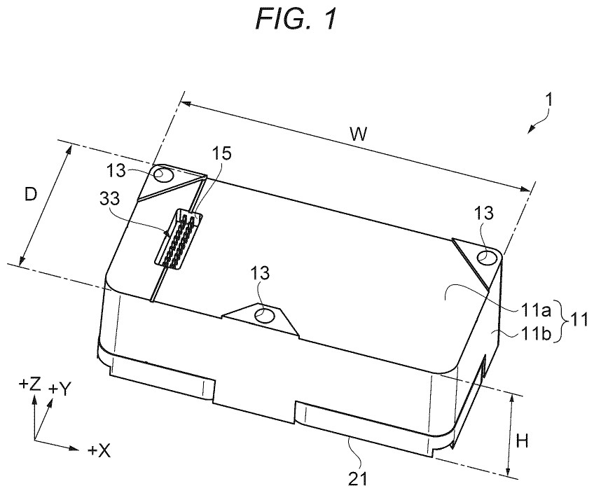

FIG. 1 illustrates an external configuration of an inertial measurement device 1. The inertial measurement device 1 is a measurement device that measures a physical quantity using inertia. As an example, the inertial measurement device 1 measures acceleration as a physical quantity. The inertial measurement device 1 may measure a physical quantity different from the acceleration.

The inertial measurement device 1 illustrated in FIG. 1 is shaped like a rectangular parallelepiped having a width W, a depth D, and a height H. The width W is a length along a long side of the inertial measurement device 1. The depth D is a length along a short side of the inertial measurement device 1. The height H is a length along a side orthogonal to the long side and the short side. An appearance of the inertial measurement device 1 is formed of a container 11 and a lid 21.

A plurality of drawings including FIG. 1 illustrates an X-Y-Z coordinate system. The X axis is an axis along the long side of the inertial measurement device 1. The +X direction is a direction from the left to the right of the long side of the inertial measurement device 1 illustrated in FIG. 1. The −X direction is a direction from the right to the left of the long side of the inertial measurement device 1 illustrated in FIG. 1. The Y axis is an axis along the short side of the inertial measurement device 1. The +Y direction is a direction from the front to the back of the short side of the inertial measurement device 1 illustrated in FIG. 1. The −Y direction is a direction from the back to the front of the short side of the inertial measurement device 1 illustrated in FIG. 1. The Z axis is an axis along the side orthogonal to the long side and the short side of the inertial measurement device 1. The +Z direction is a direction from the bottom to the top of the inertial measurement device 1 illustrated in FIG. 1. The −Z direction is a direction from the top to the bottom of the inertial measurement device 1 illustrated in FIG. 1.

The container 11 houses a circuit board 31 described later. The container 11 is a box-shaped body having an opening at the −Z direction side. The container 11 constitutes a part of an exterior housing of the inertial measurement device 1. The container 11 is formed of a metal material such as aluminum. The container 11 has a bottom portion 11a and a side portion 11b. As an example, the bottom portion 11a is formed in a flat plate shape. Screw holes 13 and an opening 15 are provided to the bottom portion 11a. The side portion 11b is a frame-shaped member extending toward the −Z direction from an outer peripheral portion of the bottom portion 11a.

The screw holes 13 are disposed in an outer peripheral portion of the inertial measurement device 1. The inertial measurement device 1 illustrated in FIG. 1 is provided with three screw holes 13. The three screw holes 13 are disposed at two corner portions and a central portion of the long side of the inertial measurement device 1. A fixation screw (not illustrated) is inserted into the screw hole 13. The inertial measurement device 1 is fixed to a mounting target surface of a mounting target body with the fixation screw. The inertial measurement device 1 is used in a state of being directly or indirectly fixed to the mounting target surface of the mounting target body. The mounting target body is a structure such as a building, a bridge, or a machine. The structure may be a moving body such as an automobile, a drone, a robot, or a ship.

A connector 33 described later is inserted into the opening 15. The connector 33 is provided to the circuit board 31 housed in the container 11. The opening 15 allows the connector 33 provided to the circuit board 31 to access the outside of the container 11.

The lid 21 is attached to a position at the −Z direction side of the container 11. The lid 21 covers an opening at the −Z direction side of the container 11. The lid 21 may be directly attached to the container 11, or may be attached via a seal member (not illustrated).

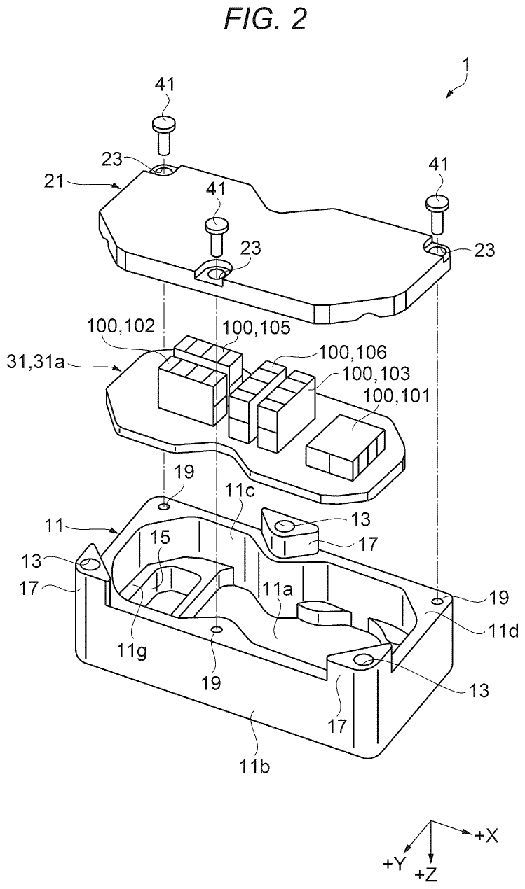

FIG. 2 illustrates an exploded perspective view of the inertial measurement device 1. FIG. 2 illustrates a state when the inertial measurement device 1 is disassembled. The inertial measurement device 1 is disassembled into the container 11, the lid 21, and a first circuit board 31a which is an example of the circuit board 31.

The container 11 has the bottom portion 11a having the opening 15, and the side portion 11b having an inner surface 11c and a support surface 11d. The container 11 is provided with the screw holes 13, a fixation protrusions 17, and lid fixing screw holes 19.

The inner surface 11c is an inner peripheral surface of the side portion 11b. The support surface 11d is an end surface at the −Z direction side of the side portion 11b. The support surface 11d faces the lid 21. The support surface 11d supports the lid 21.

The fixation protrusions 17 are provided to the support surface 11d. In the container 11 illustrated in FIG. 2, three fixation protrusions 17 are provided to the support surface 11d. The fixation protrusions 17 protrude from the support surface 11d toward the −Z direction. The screw hole 13 is formed in each of the three fixation protrusions 17.

The lid fixing screw holes 19 are provided to the support surface 11d. In the container 11 illustrated in FIG. 2, three lid fixing screw holes 19 are provided to the support surface 11d. The three lid fixing screw holes 19 are disposed at corners of the container 11 and at the center of a long side. A lid fixation screw 41 is inserted into the lid fixing screw hole 19.

The container 11 illustrated in FIG. 2 has a rectangular shape in a plan view from the +Z direction, but is not limited thereto. The container 11 illustrated in FIG. 2 may be configured in a polygonal shape such as a square, a hexagon, or an octagon in the plan view from the +Z direction. The external shape of the container 11 can appropriately be set.

Three through holes 23 are provided to the lid 21. The through holes 23 are formed at positions corresponding to the lid fixing screw holes 19 when the lid 21 is attached to the container 11. The lid fixation screw 41 is inserted into each of the three through holes 23. The lid 21 is attached to the container 11 with the lid fixation screws 41.

The circuit board 31 is housed in the container 11. The circuit board 31 is a multilayer board provided with a plurality of through holes and so on. The circuit board 31 is formed of, for example, a glass epoxy substrate. The circuit board 31 may be formed of a composite substrate, a ceramic substrate, or the like. The connector 33, a processing circuit 35 (not illustrated in FIG. 2), and a plurality of inertial sensors 100 are mounted on the circuit board 31. The processing circuit 35 and the inertial sensors 100 will be described later. A first inertial sensor 101, a second inertial sensor 102, a third inertial sensor 103, a fourth inertial sensor 104, a fifth inertial sensor 105, and a sixth inertial sensor 106 are mounted on the first circuit board 31a illustrated in FIG. 2 as the plurality of inertial sensors 100. The fourth inertial sensor 104 is not illustrated in FIG. 2. The circuit board 31 such as the first circuit board 31a corresponds to an example of a board.

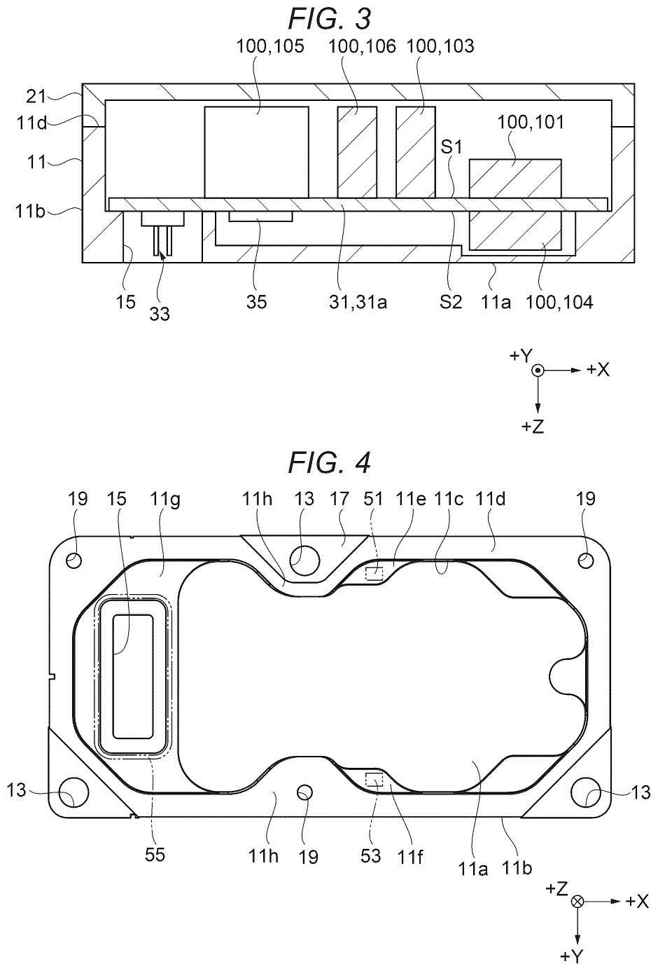

FIG. 3 illustrates a schematic configuration of the inertial measurement device 1. FIG. 3 illustrates an X-Z cross section along the Y axis of a substantially central portion of the inertial measurement device 1. FIG. 3 illustrates an arrangement configuration and a cross-sectional configuration of the first circuit board 31a which is an example of the circuit board 31.

Electronic components (not illustrated) and so on are placed on the first circuit board 31a. The processing circuit 35, the six inertial sensors 100, and the connector 33 mounted on the first circuit board 31a are electrically coupled via wiring (not illustrated).

The first circuit board 31a has a first surface S1 and a second surface S2. The first surface S1 is a surface at the −Z direction side of the first circuit board 31a. The second surface S2 is a surface at the +Z direction side of the first circuit board 31a. The first circuit board 31a is in contact with the container 11 at the second surface S2 and is supported by the container 11.

The first inertial sensor 101, the second inertial sensor 102 (not illustrated), the third inertial sensor 103, the fifth inertial sensor 105, and the sixth inertial sensor 106 are placed on the first surface S1. The connector 33, the processing circuit 35, and the fourth inertial sensor 104 are placed on the second surface S2. The fourth inertial sensor 104 is disposed so as to be opposed to the first inertial sensor 101 across the first circuit board 31a.

The connector 33 is coupled to an external device. Drive voltages are input to the connector 33 from the external device. The connector 33 outputs various signals to the external device. The connector 33 is a plug having a plurality of pins as an example. The external device includes a socket to be coupled to the plug.

The processing circuit 35 controls each part of the inertial measurement device 1. A detection value of each of the inertial sensors 100 is input to the processing circuit 35. The processing circuit 35 outputs, as a signal, data calculated using the detection value. The processing circuit 35 is, for example, a micro controller unit (MCU). The processing circuit 35 includes a storage medium such as a nonvolatile memory, and an analog-to-digital converter. The storage medium stores a program for operating the inertial measurement device 1. The processing circuit 35 corresponds to an example of a control circuit.

FIG. 4 illustrates a schematic configuration of the container 11. FIG. 4 illustrates a plan view of the container 11 from the −Z direction. FIG. 4 shows an internal configuration of the container 11. FIG. 4 virtually shows a first fixation member 51, a second fixation member 53, and a connector fixation member 55.

The container 11 includes a first pedestal 11e, a second pedestal 11f, a third pedestal 11g, and two protrusions 11h.

The first pedestal 11e is disposed inside the container 11. The first pedestal 11e is disposed at a position at the −Y direction side inside the container 11. The first pedestal 11e is disposed at a position in contact with the inner surface 11c of the side portion 11b. The first pedestal 11e supports the circuit board 31 at a position at the −Y direction side. The first pedestal 11e is disposed at an intermediate position of the container 11 along the X axis inside the container 11. The first pedestal 11e supports the circuit board 31 at an intermediate position of the container 11 along the X axis inside the container 11.

The second pedestal 11f is disposed inside the container 11. The second pedestal 11f is disposed at a position at the +Y direction side inside the container 11. The second pedestal 11f is disposed at a position in contact with the inner surface 11c of the side portion 11b. The second pedestal 11f supports the circuit board 31 at a position at the +Y direction side. The second pedestal 11f is disposed at an intermediate position of the container 11 along the X axis inside the container 11. The second pedestal 11f supports the circuit board 1 at an intermediate position of the container 11 along the X axis inside the container 11.

The third pedestal 11g is provided to an outer peripheral portion of the opening 15. The third pedestal 11g is disposed at a position at the −X direction side inside the container 11. The third pedestal 11g supports the circuit board 31 at a position at the −X direction side inside the container 11. The first pedestal 11e, the second pedestal 11f, and the third pedestal 11g each support the circuit board 31 in parallel to the X-Y plane on a surface facing to the −Z direction.

The protrusions 11h are regions which protrude from the side portion 11b toward the inside of the container 11. The protrusions 11h are each formed in a ridge shape in an area from the bottom portion 11a up to the support surface 11d at the −Z direction side. One of the two protrusions 11h is disposed at a substantially central portion of a long side at the −Y direction side of the side portion 11b. The other of the two protrusions 11h is disposed at a substantially central portion of the long side at the +Y direction side of the side portion 11b. The two protrusions 11h are formed in a shape corresponding to the outer peripheral shape of the circuit board 31.

The first fixation member 51 fixes the circuit board 31 to the container 11. The first fixation member 51 illustrated in FIG. 4 is provided to the first pedestal 11e. The first fixation member 51 fixes the circuit board 31 to the first pedestal 11e of the container 11. The first fixation member 51 is, for example, an adhesive. The first fixation member 51 is not limited to the adhesive. The configuration of the first fixation member 51 is not limited as long as the circuit board 31 can be fixed to the container 11 with the configuration.

The second fixation member 53 fixes the circuit board 31 to the container 11. The second fixation member 53 illustrated in FIG. 4 is provided to the second pedestal 11f. The second fixation member 53 fixes the circuit board 31 to the second pedestal 11f of the container 11. The second fixation member 53 is, for example, an adhesive. The second fixation member 53 is not limited to the adhesive. The configuration of the second fixation member 53 is not limited as long as the circuit board 31 can be fixed to the container 11 with the configuration.

The connector fixation member 55 fixes the circuit board 31 to the container 11. The connector fixation member 55 is disposed in a ring shape at a position of the outer peripheral portion of the opening 15. The connector fixation member 55 fixes the circuit board 31 to the third pedestal 11g of the container 11. The connector fixation member 55 is, for example, an adhesive. The connector fixation member 55 is not limited to the adhesive. The configuration of the connector fixation member 55 is not limited as long as the circuit board 31 can be fixed to the container 11 with the configuration.

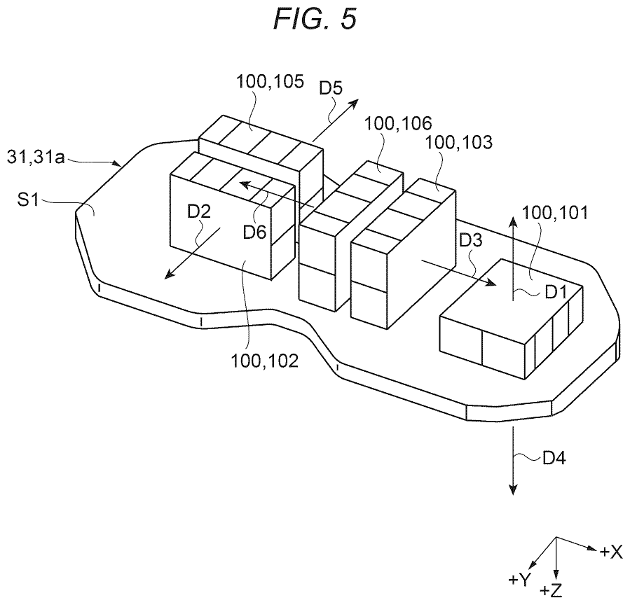

FIG. 5 is a perspective view illustrating a schematic configuration of the first circuit board 31a which is an example of the circuit board 31. FIG. 5 illustrates a configuration on the first surface S1 of the first circuit board 31a. The six inertial sensors 100 are placed on the first circuit board 31a.

The inertial sensors 100 each detect a physical quantity using inertia. The inertial sensors 100 installed in the inertial measurement device 1 are each an acceleration sensor that detects acceleration along one axis as a physical quantity. The inertial sensors 100 installed in the inertial measurement device 1 are not limited to the acceleration sensors. The inertial sensors 100 may be angular velocity sensors. The inertial sensors 100 may be sensors that detect multi-axis physical quantities along two or more axes.

The first inertial sensor 101 and the fourth inertial sensor 104 are disposed so as to be opposed to each other. The second inertial sensor 102 and the fifth inertial sensor 105 are disposed so as to be opposed to each other. The third inertial sensor 103 and the sixth inertial sensor 106 are disposed so as to be opposed to each other.

The first inertial sensor 101 detects a first detection value representing positive acceleration in a first detection direction D1 as a positive value. The first detection direction D1 is a direction along the Z axis. The first detection direction D1 corresponds to the −Z direction. The first detection value is a Z-axis acceleration detection value representing an acceleration component parallel to the Z axis. The fourth inertial sensor 104 detects a fourth detection value representing positive acceleration in a fourth detection direction D4 as a positive value. The fourth detection direction D4 is a direction along the Z axis. The fourth detection direction D4 corresponds to the +Z direction. The first detection direction D1 and the fourth detection direction D4 are opposite to each other. The fourth detection value is the Z-axis acceleration detection value opposite in phase to the first detection value.

The second inertial sensor 102 detects a second detection value representing positive acceleration in a second detection direction D2 as a positive value. The second detection direction D2 is a direction along the Y axis. The second detection direction D2 corresponds to the +Y direction. The second detection value is a Y-axis acceleration detection value representing an acceleration component parallel to the Y axis. The fifth inertial sensor 105 detects a fifth detection value representing positive acceleration in a fifth detection direction D5 as a positive value. The fifth detection direction D5 is a direction along the Y axis. The fifth detection direction D5 corresponds to the −Y direction. The second detection direction D2 and the fifth detection direction D5 are opposite to each other. The fifth detection value is the Y-axis acceleration detection value opposite in phase to the second detection value.

The third inertial sensor 103 detects a third detection value representing positive acceleration in a third detection direction D3 as a positive value. The third detection direction D3 is a direction along the X axis. The third detection direction D3 corresponds to the +X direction. The third detection value is an X-axis acceleration detection value representing an acceleration component parallel to the X axis. The sixth inertial sensor 106 detects a sixth detection value representing positive acceleration in a sixth detection direction D6 as a positive value. The sixth detection direction D6 is a direction along the X axis. The sixth detection direction D6 corresponds to the −X direction. The third detection direction D3 and the sixth detection direction D6 are opposite to each other. The sixth detection value is the X-axis acceleration detection value opposite in phase to the third detection value.

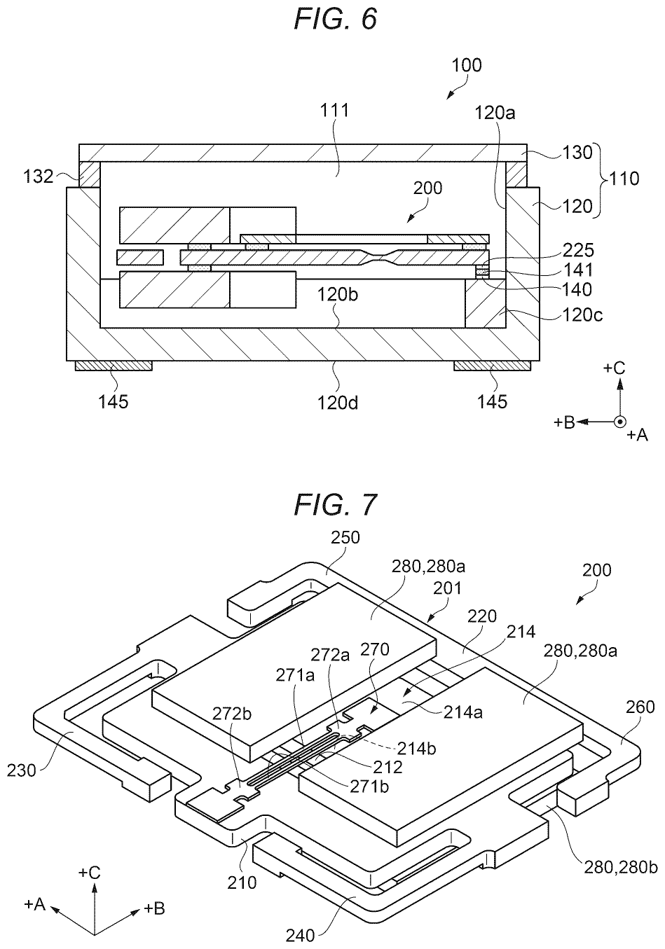

FIG. 6 illustrates a schematic configuration of the inertial sensor 100. FIG. 6 schematically illustrates a cross section of the inertial sensor 100.

FIG. 6 and FIG. 7 described later illustrate an A-B-C coordinate system. The A-B-C coordinate system is a local coordinate system representing axes of the inertial sensor 100. The A axis and the B axis are axes parallel to a plane of a substrate structure 201 shaped like a flat plate described later. The A axis and the B axis are orthogonal to each other. The B axis is an axis parallel to a direction in which a vibrator element 270 described later extends. The +B direction is a direction from the right to the left of the inertial sensor 100 illustrated in FIG. 6. The −B direction is a direction from the left to the right of the inertial sensor 100 illustrated in FIG. 6. The A axis is an axis orthogonal to the direction in which the vibrator element 270 extends. The +A direction is a direction from the back to the front of the inertial sensor 100 illustrated in FIG. 6. The −A direction is a direction from the front to the back of the inertial sensor 100 illustrated in FIG. 6. The C axis is an axis orthogonal to the A axis and the B axis. The +C direction is a direction from the bottom to the top of the inertial sensor 100 illustrated in FIG. 6. The −C direction is a direction from the top to the bottom of the inertial sensor 100 illustrated in FIG. 6.

The inertial sensor 100 includes a sensor element 200 and a package 110. The inertial sensor 100 houses the sensor element 200 in a housing space 111 formed by the package 110.

The package 110 is a housing which defines the housing space 111. The package 110 includes a package base 120 and a lid 130. The housing space 111 is covered with the package base 120 and the lid 130.

The package base 120 is a box-shaped body having an opening at the +C direction side. The package base 120 has an inner side surface 120a, an inner bottom surface 120b, a step portion 120c, and an outer bottom surface 120d. The inner side surface 120a and the inner bottom surface 120b are surfaces inside the package base 120. The outer bottom surface 120d is an outer surface of the package base 120. The package base 120 includes an external terminal 145.

The step portion 120c is formed inside the package base 120. The step portion 120c is disposed in a frame shape along the inner side surface 120a. The step portion 120c is a region protruding from the inner bottom surface 120b toward the +C direction. The step portion 120c is provided with a plurality of internal terminals 140.

The plurality of internal terminals 140 is coupled to fixation portion coupling terminals 225 provided respectively to a first support portion 230, a second support portion 240, a third support portion 250, and a fourth support portion 260 of the sensor element 200. The first support portion 230, the second support portion 240, the third support portion 250, and the fourth support portion 260 will be described later. The internal terminal 140 and the fixation portion coupling terminal 225 are electrically and mechanically coupled via an electrically-conductive adhesive 141.

The external terminal 145 is disposed on the outer bottom surface 120d. The external terminal 145 is electrically coupled to the internal terminal 140 via internal wiring not illustrated. The external terminal 145 is electrically coupled to the inertial sensor 100 via wiring provided to the circuit board 31. The external terminal 145 may be disposed on an outer surface of the package base 120 different from the outer bottom surface 120d.

The lid 130 is a member shaped like a flat plate. The lid 130 closes the opening of the package base 120. The lid 130 is attached to the package base 120 via a lid bonding member 132. By the lid 130 closing the opening of the package base 120, the housing space 111 in which the sensor element 200 is housed is airtightly sealed.

FIG. 7 illustrates a schematic configuration of the sensor element 200. FIG. 7 is a perspective view illustrating the sensor element 200. The sensor element 200 includes the substrate structure 201, the vibrator element 270, and mass portions 280.

The substrate structure 201 is shaped like a flat plate having a principal surface parallel to the A-B plane. The substrate structure 201 includes a base portion 210, a movable portion 214, a coupling portion 220, and a plurality of support portions. The plurality of support portions is the first support portion 230, the second support portion 240, the third support portion 250, and the fourth support portion 260. The number of support portions may be two or three. The substrate structure 201 is formed of, for example, a quartz crystal substrate. The substrate structure 201 may be made of a material other than quartz crystal.

The base portion 210 is coupled to the movable portion 214 via a joint portion 212 shaped like a groove along the A axis. The base portion 210 supports the movable portion 214 so as to be able to swing. The base portion 210 has a U-shape bending at a right angle in a plan view from the +C direction. The coupling portion 220 couples both ends of the U-shape formed by the base portion 210 along the A axis at the +B direction side of the movable portion 214. Accordingly, the base portion 210 and the coupling portion 220 each have a schematic frame shape in a plan view. The first support portion 230 and the second support portion 240 are coupled at the +A direction side and the −A direction side of the base portion 210. The third support portion 250 and the fourth support portion 260 are coupled to the vicinity of the coupling portion 220 of the base portion 210.

The joint portion 212 is disposed between the base portion 210 and the movable portion 214. The joint portion 212 couples the base portion 210 and the movable portion 214. The thickness of the joint portion 212 along the C axis is thinner than the thickness of the base portion 210 along the C axis and the thickness of the movable portion 214 along the C axis. The joint portion 212 is formed in a constricted shape at both sides along the C axis in a plan view from the +A direction. The joint portion 212 functions as a fulcrum when the movable portion 214 is displaced with respect to the base portion 210.

The movable portion 214 is coupled to the base portion 210 via the joint portion 212. The movable portion 214 is shaped like a flat plate. The movable portion 214 has a first principal surface 214a and a second principal surface 214b. The first principal surface 214a is a surface at the +C direction side of the movable portion 214. The second principal surface 214b is a surface at the −C direction side of the movable portion 214. The first principal surface 214a and the second principal surface 214b have a front-back relationship. The movable portion 214 is displaced along the C axis with the joint portion 212 as a fulcrum in accordance with acceleration along the C axis. The joint portion 212 and the movable portion 214 function as a cantilever.

The first support portion 230 is shaped like an arm bending at a right angle along the A axis and the B axis. The first support portion 230 is disposed at a position at the +A direction side and the −B direction side of the sensor element 200. The second support portion 240 is shaped like an arm bending at a right angle along the A axis and the B axis. The second support portion 240 is disposed at a position at the −A direction side and the −B direction side of the sensor element 200. The first support portion 230 and the second support portion 240 are disposed symmetrically about a center line of the vibrator element 270 along the B axis in the plan view from the +C direction.

The third support portion 250 is shaped like an arm bending at a right angle along the A axis and the B axis. The third support portion 250 is disposed at a position at the +A direction side and the +B direction side of the sensor element 200. The fourth support portion 260 is shaped like an arm bending at a right angle along the A axis and the B axis. The fourth support portion 260 is disposed at a position at the −A direction side and the +B direction side of the sensor element 200. The third support portion 250 and the fourth support portion 260 are disposed symmetrically about the center line of the vibrator element 270 along the B axis in the plan view from the +C direction.

Distal end portions of the first support portion 230, the second support portion 240, the third support portion 250, and the fourth support portion 260 are coupled to the step portion 120c of the package 110. The first support portion 230, the second support portion 240, the third support portion 250, and the fourth support portion 260 support the base portion 210 in the housing space 111.

Both ends along the B axis of the vibrator element 270 are coupled to the base portion 210 and the movable portion 214 of the substrate structure 201. The vibrator element 270 is provided to the base portion 210 and the movable portion 214 straddling the joint portion 212.

As an example, the vibrator element 270 is formed of a quartz crystal substrate. The vibrator element 270 may be formed of a piezoelectric material other than quartz crystal. The vibrator element 270 and the substrate structure 201 are preferably formed of the same material. By forming the vibrator element 270 and the substrate structure 201 of the same material, a difference in linear expansion coefficient between the substrate structure 201 and the vibrator element 270 is reduced. It becomes possible to suppress stress applied from the substrate structure 201 to the vibrator element 270 due to the difference in linear expansion coefficient.

The vibrator element 270 is a dual-tuning-fork vibrator element, as an example. The vibrator element 270 includes a first vibrating beam portion 271a, a second vibrating beam portion 271b, a first element base portion 272a, and a second element base portion 272b. The first vibrating beam portion 271a and the second vibrating beam portion 271b each extend along the B axis. The first element base portion 272a is coupled to end portions at the +B direction side of the first vibrating beam portion 271a and the second vibrating beam portion 271b. The first element base portion 272a is coupled to the movable portion 214. The second element base portion 272b is coupled to end portions at the −B direction side of the first vibrating beam portion 271a and the second vibrating beam portion 271b. The second element base portion 272b is coupled to the base portion 210 of the substrate structure 201. The vibrator element 270 is not limited to the dual-tuning-fork vibrator element. The vibrator element 270 may be a single beam type vibrator element having a single vibrating beam portion.

The vibrator element 270 includes excitation electrodes (not illustrated) provided on surfaces thereof. When a drive signal of an AC voltage is applied to the excitation electrodes provided to the vibrator element 270, the first vibrating beam portion 271a and the second vibrating beam portion 271b perform a flexural vibration of getting away from each other and coming closer to each other along the A axis. The vibrator element 270 functions as a resonator.

The sensor element 200 includes a plurality of mass portions 280. Out of the plurality of mass portions 280, first mass portions 280a are disposed on the first principal surface 214a of the movable portion 214. Two first mass portions 280a are disposed on the first principal surface 214a. The first mass portions 280a are bonded to the first principal surface 214a via bonding materials (not illustrated). Out of the plurality of mass portions 280, second mass portions 280b are disposed on the second principal surface 214b of the movable portion 214. Two second mass portions 280b are disposed on the second principal surface 214b. The second mass portions 280b are bonded to the second principal surface 214b via bonding materials (not illustrated). The mass portions 280 are made of metal such as copper or gold. The number of mass portions 280 may be one.

When the acceleration in the +C direction is applied to the sensor element 200, the movable portion 214 is displaced in the −C direction with the joint portion 212 as a fulcrum. When the movable portion 214 is displaced in the −C direction, forces in directions of getting away from each other along the B axis are applied to the first element base portion 272a and the second element base portion 272b. Tensile stress is generated in the first vibrating beam portion 271a and the second vibrating beam portion 271b. A resonance frequency of the first vibrating beam portion 271a and the second vibrating beam portion 271b rises due to the tensile stress.

When the acceleration in the −C direction is applied to the sensor element 200, the movable portion 214 is displaced in the +C direction with the joint portion 212 as a fulcrum. When the movable portion 214 is displaced in the +C direction, forces in directions of coming closer to each other along the B axis are applied to the first element base portion 272a and the second element base portion 272b. Compressive stress is generated in the first vibrating beam portion 271a and the second vibrating beam portion 271b. Due to the compressive stress, the resonance frequency of the first vibrating beam portion 271a and the second vibrating beam portion 271b decrease.

The sensor element 200 can detect the acceleration in the +C direction and the −C direction based on the resonance frequency of the vibrator element 270. The sensor element 200 is a frequency-change type acceleration sensor element taking the C axis as a detection axis.

In the sensor element 200 provided to the inertial sensor 100, when the drive signal is applied to the electrodes via the external terminal 145, the internal terminal 140, the fixation portion coupling terminal 225, and so on, the first vibrating beam portion 271a and the second vibrating beam portion 271b resonate at a predetermined frequency. The inertial sensor 100 outputs, as an output signal, the resonance frequency of the sensor element 200 that changes in accordance with the acceleration.

The inertial sensor 100 is a frequency-change type acceleration sensor taking the C axis as the detection axis. The inertial sensor 100 can detect acceleration in a desired direction by being disposed in a posture in which the C axis as the detection axis coincides with the desired direction.

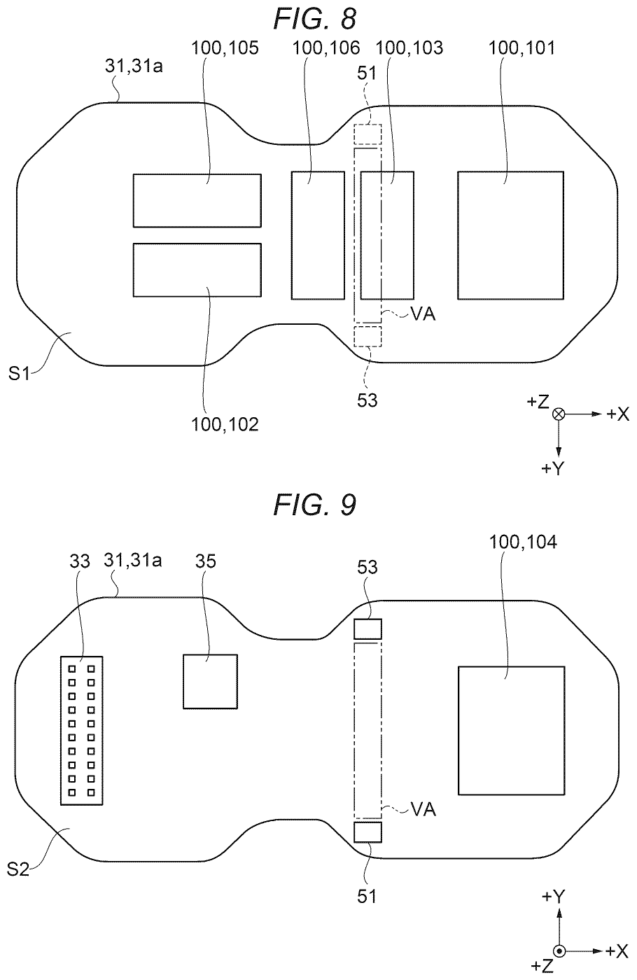

FIGS. 8 and 9 illustrate the schematic configuration of the first circuit board 31a which is an example of the circuit board 31. FIG. 8 illustrates a plan view of the first circuit board 31a from the −Z direction. FIG. 8 illustrates the first surface S1 side of the first circuit board 31a. FIG. 8 virtually shows the first fixation member 51 and the second fixation member 53. FIG. 9 illustrates the plan view of the first circuit board 31a from the +Z direction. FIG. 9 illustrates the second surface S2 side of the first circuit board 31a. FIG. 9 illustrates the first fixation member 51 and the second fixation member 53.

The first fixation member 51 fixes the first circuit board 31a to the first pedestal 11e of the container 11 at an intermediate position along the X axis of the first circuit board 31a and at a position in the vicinity of an end portion at the −Y direction side of the first circuit board 31a.

The second fixation member 53 fixes the first circuit board 31a to the second pedestal 11f of the container 11 at a position at the +Y direction side of the first fixation member 51, and in the vicinity of an end portion at the +Y direction side of the first circuit board 31a.

The first inertial sensor 101, the second inertial sensor 102, the third inertial sensor 103, the fifth inertial sensor 105, and the sixth inertial sensor 106 are disposed on the first surface S1 of the first circuit board 31a. The first inertial sensor 101, the second inertial sensor 102, and the third inertial sensor 103 are disposed on the first circuit board 31a in the order of the first inertial sensor 101, the third inertial sensor 103, and the second inertial sensor 102 in the −X direction along the X axis. The X axis corresponds to an example of the first axis. The −X direction corresponds to an example of the first direction. The fourth inertial sensor 104, the connector 33, and the processing circuit 35 are disposed on the second surface S2 of the first circuit board 31a.

The C axis of the sensor element 200 provided to the first inertial sensor 101 coincides or substantially coincides with the Z axis. The Z axis is an axis perpendicular to the first circuit board 31a. The Z axis corresponds to an example of a vertical axis. The vibrator element 270 of the first inertial sensor 101 is disposed such that the B axis corresponds to the X axis, and vibrates along the Y axis. The first inertial sensor 101 corresponds to an example of a first sensor. The first detection value, which is the Z-axis acceleration detection value, corresponds to an example of a physical quantity along the vertical axis.

The C axis of the sensor element 200 provided to the second inertial sensor 102 coincides or substantially coincides with the Y axis. The Y axis corresponds to an example of a second axis. The vibrator element 270 of the second inertial sensor 102 is disposed such that the B axis corresponds to the Z axis, and vibrates along the X axis. The second inertial sensor 102 corresponds to an example of a second sensor. The second detection value, which is the Y-axis acceleration detection value, corresponds to an example of a physical quantity along the second axis.

The C axis of the sensor element 200 provided to the third inertial sensor 103 coincides or substantially coincides with the X axis. The vibrator element 270 of the third inertial sensor 103 is disposed such that the B axis corresponds to the Z axis, and vibrates along the Y axis. The third inertial sensor 103 corresponds to an example of a third sensor. The third detection value, which is the X-axis acceleration detection value, corresponds to an example of a physical quantity along the first axis.

The C axis of the sensor element 200 provided to the fourth inertial sensor 104 coincides or substantially coincides with the Z axis. The vibrator element 270 of the fourth inertial sensor 104 is disposed such that the B axis corresponds to the X axis, and vibrates along the Y axis. The fourth inertial sensor 104 corresponds to an example of a fourth sensor. The fourth detection value, which is the Z-axis acceleration detection value, corresponds to an example of a physical quantity along the vertical axis.

The first inertial sensor 101 and the fourth inertial sensor 104 are disposed so as to be opposed to each other along the Z axis to thereby form a differential pair, and can generate a Z-axis differential signal. The Z-axis differential signal represents a difference between the first detection value detected by the first inertial sensor 101 and the fourth detection value detected by the fourth inertial sensor 104. Due to the Z-axis differential signal is generated, noise caused by stress from the first circuit board 31a can be canceled out. Therefore, the accuracy of the measurement value of the acceleration along the Z axis output from the inertial measurement device 1 is improved.

The C axis of the sensor element 200 provided to the fifth inertial sensor 105 coincides or substantially coincides with the Y axis. The vibrator element 270 of the fifth inertial sensor 105 is disposed such that the B axis corresponds to the Z axis, and vibrates along the X axis. The fifth inertial sensor 105 corresponds to an example of a fifth sensor. The fifth detection value, which is the Y-axis acceleration detection value, corresponds to an example of a physical quantity along the second axis.

The second inertial sensor 102 and the fifth inertial sensor 105 are disposed so as to be opposed to each other along the Y axis to thereby form a differential pair, and can generate a Y-axis differential signal. The Y-axis differential signal represents a difference between the second detection value detected by the second inertial sensor 102 and the fifth detection value detected by the fifth inertial sensor 105. Due to the Y-axis differential signal is generated, the noise caused by the stress from the first circuit board 31a can be canceled out. Therefore, the accuracy of the measurement value of the acceleration along the Y axis output from the inertial measurement device 1 is improved.

The C axis of the sensor element 200 provided to the sixth inertial sensor 106 coincides or substantially coincides with the X axis. The vibrator element 270 of the sixth inertial sensor 106 is disposed such that the B axis corresponds to the Z axis, and vibrates along the Y axis. The sixth inertial sensor 106 corresponds to an example of a sixth sensor. The sixth detection value, which is the X-axis acceleration detection value, corresponds to an example of a physical quantity along the first axis.

The third inertial sensor 103 and the sixth inertial sensor 106 are disposed so as to be opposed to each other along the X axis to thereby form a differential pair, and can generate an X-axis differential signal. The X-axis differential signal represents a difference between the third detection value detected by the third inertial sensor 103 and the sixth detection value detected by the sixth inertial sensor 106. Due to the X-axis differential signal is generated, the noise caused by the stress from the first circuit board 31a can be canceled out. Therefore, the accuracy of the measurement value of the acceleration along the X axis output from the inertial measurement device 1 is improved.

The inertial sensor 100 has a natural frequency in the vibrator element 270. When the plurality of inertial sensors 100 is simply placed on the circuit board 31, interference due to the respective natural frequencies of the plurality of inertial sensors 100 may occur. That is, when a frequency difference between the natural frequencies of the plurality of inertial sensors 100 is within the measurement band, an error in a measurement signal increases. As an example, when the measurement band is 0 Hz to 460 Hz and the frequency difference between the natural frequencies of the two inertial sensors 100 is 350 Hz, the error in the measurement signal due to the natural frequencies increases. When the influence of the vibration interference is measurable as described above, a manufacturer of the inertial measurement device 1 needs to perform, in advance, pairing for selecting a combination in which the frequency difference between the natural frequencies of the plurality of inertial sensors 100 does not fall within the measurement band before mounting the inertial sensors 100 on the circuit board 31.

The pairing is affected by the vibration directions of the vibrator elements 270 provided to the inertial sensors 100. When the vibration directions of the vibrator elements 270 in the two inertial sensors 100 are along the same axis, higher precision is required for the pairing of the two inertial sensors 100. In the case of the plurality of inertial sensors 100 illustrated in FIG. 8, the vibrator element 270 in the first inertial sensor 101 vibrates along the Y axis, and the vibrator element 270 in the second inertial sensor 102 vibrates along the X axis. Further, since the first inertial sensor 101 and the second inertial sensor 102 are separated by a virtual area VA between the first fixation member 51 and the second fixation member 53, interference of vibration is reduced to a negligible level, and pairing is unnecessary.

In the first circuit board 31a illustrated in FIG. 8, the first inertial sensor 101, the third inertial sensor 103, and the second inertial sensor 102 are placed in the order of the first inertial sensor 101, the third inertial sensor 103, and the second inertial sensor 102 in the −X direction along the X axis.

The fourth inertial sensor 104 is disposed at a second-surface opposed position opposed to the first inertial sensor 101 across the first circuit board 31a. The fifth inertial sensor 105 is disposed at a Y-axis opposed position at the −Y direction side along the Y axis with respect to the second inertial sensor 102. The sixth inertial sensor 106 is disposed at an X-axis opposed position at the −X direction side along the X axis with respect to the third inertial sensor 103.

The first fixation member 51 is disposed between the first inertial sensor 101 and the second inertial sensor 102 in a direction along the X axis. The first inertial sensor 101, the first fixation member 51, and the second inertial sensor 102 are disposed in the order of the first inertial sensor 101, the first fixation member 51, and the second inertial sensor 102 in the −X direction along the X axis.

The second fixation member 53 is disposed at the +Y direction side orthogonal to the X axis with respect to the first fixation member 51. The second fixation member 53 is disposed between the first inertial sensor 101 and the second inertial sensor 102 in a direction along the X axis. The second fixation member 53 may be disposed at a position at a crossing direction side with respect to the X axis from the first fixation member 51 as long as the second fixation member 53 is disposed between the first inertial sensor 101 and the second inertial sensor 102 in a direction along the X axis. The crossing direction includes a direction inclined with respect to the Y axis.

The first inertial sensor 101 and the second inertial sensor 102 are disposed at positions across the virtual area VA between the first fixation member 51 and the second fixation member 53 when viewed in a direction along the Z axis. That is, the second inertial sensor 102 is separated from the first inertial sensor 101 by the virtual area VA when viewed in a direction along the Z axis. By disposing the first fixation member 51 and the second fixation member 53 between the first inertial sensor 101 and the second inertial sensor 102, the interference between the natural frequencies of the first inertial sensor 101 and the second inertial sensor 102 in which the vibrator elements 270 vibrate in respective directions different from each other is further suppressed. Therefore, pairing between the first inertial sensor 101 and the second inertial sensor 102 is facilitated. Alternatively, pairing between the first inertial sensor 101 and the second inertial sensor 102 becomes unnecessary.

When the six inertial sensors 100 are mounted on the first circuit board 31a, pairing is performed for each combination of the inertial sensors 100. Since the pairing between the first inertial sensor 101 and the second inertial sensor 102 becomes unnecessary, the labor of mounting the inertial sensor 100 on the first circuit board 31a is reduced. Further, the number of inertial sensors 100 that become unavailable due to the pairing is reduced, and the manufacturing yield is improved.

The third inertial sensor 103 is disposed on the virtual area VA between the first fixation member 51 and the second fixation member 53. The virtual area VA is a band-shaped virtual area connecting the first fixation member 51 and the second fixation member 53 along the Y axis. By disposing the third inertial sensor 103 on the virtual area VA, the influence of the natural frequencies of the first inertial sensor 101 and the second inertial sensor 102 and the influence of the natural frequency of another inertial sensor 100 on the third inertial sensor 103 are further reduced.

As described above, by disposing the first fixation member 51 and the second fixation member 53 between the first inertial sensor 101 and the second inertial sensor 102 when viewed in a direction along the Z axis, the interference between the natural frequencies of the first inertial sensor 101 and the second inertial sensor 102 in which the vibrator elements 270 vibrate in respective directions different from each other is further suppressed. Therefore, the pairing between the first inertial sensor 101 and the second inertial sensor 102 is facilitated. Alternatively, the pairing between the first inertial sensor 101 and the second inertial sensor 102 becomes unnecessary.

Since the inertial measurement device 1 includes the third inertial sensor 103 that detects the X-axis acceleration detection value along the X axis, it is possible to measure the acceleration in the three axes.

Since the third inertial sensor 103 is disposed on the virtual area VA which connects the first fixation member 51 and the second fixation member 53 between the first inertial sensor 101 and the second inertial sensor 102, it is possible to increase rigidity and weight on the virtual area VA. Therefore, the influence of the natural frequencies of the first inertial sensor 101 and the second inertial sensor 102 and the influence of the natural frequency of another inertial sensor 100 on the third inertial sensor 103 are further reduced.

The inertial measurement device 1 includes the fourth inertial sensor 104 opposed to the first inertial sensor 101 across the first circuit board 31a, the fifth inertial sensor 105 opposed to the second inertial sensor 102 along the Y axis, and the sixth inertial sensor 106 opposed to the third inertial sensor 103 along the X axis. Since the differential pair is configured for each axis in this way, the accuracy of the measurement value of the acceleration along each axis is improved.

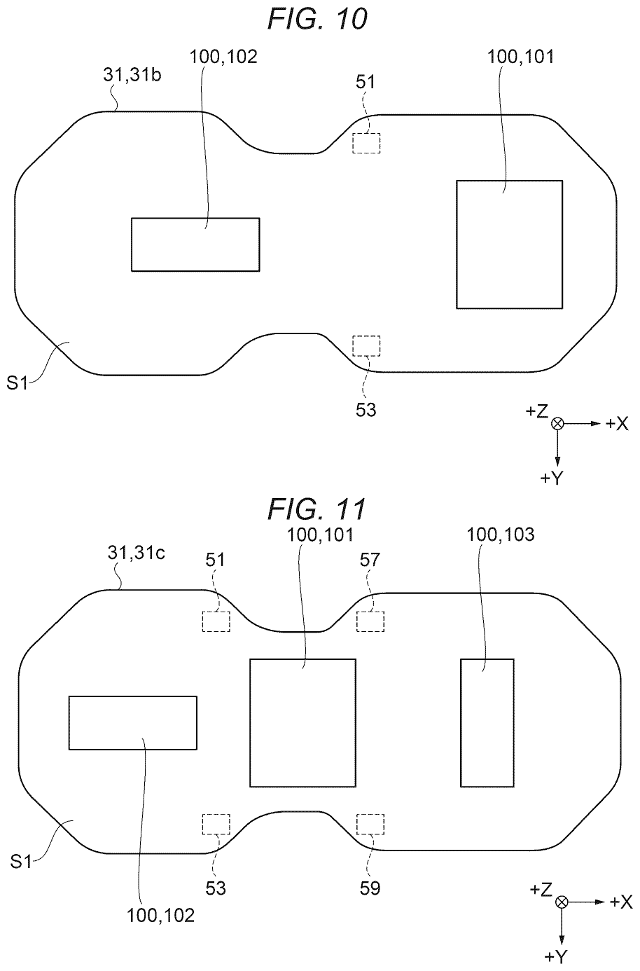

FIG. 10 illustrates a schematic configuration of a second circuit board 31b which is an example of the circuit board 31. FIG. 10 illustrates a plan view of the second circuit board 31b from the −Z direction. FIG. 10 illustrates a first surface S1 of the second circuit board 31b. FIG. 10 virtually shows the first fixation member 51 and the second fixation member 53.

Two inertial sensors 100 are mounted on the second circuit board 31b. The two inertial sensors 100 are the first inertial sensor 101 and the second inertial sensor 102. The first inertial sensor 101 and the second inertial sensor 102 are disposed at positions across the first fixation member 51 and the second fixation member 53 along the X axis.

The first fixation member 51 fixes the second circuit board 31b to the first pedestal 11e of the container 11 at an intermediate position along the X axis of the second circuit board 31b and at a position in the vicinity of an end portion at the −Y direction side of the second circuit board 31b.

The second fixation member 53 fixes the second circuit board 31b to the second pedestal 11f of the container 11 at a position at the +Y direction side of the first fixation member 51, and in the vicinity of an end portion at the +Y direction side of the second circuit board 31b.

The first inertial sensor 101 and the second inertial sensor 102 are disposed at positions across an area between the first fixation member 51 and the second fixation member 53 when viewed in a direction along the Z axis. By disposing the first fixation member 51 and the second fixation member 53 between the first inertial sensor 101 and the second inertial sensor 102, the interference between the natural frequencies of the first inertial sensor 101 and the second inertial sensor 102 in which the vibrator elements 270 vibrate in respective directions different from each other is suppressed.

FIG. 11 illustrates a schematic configuration of a third circuit board 31c which is an example of the circuit board 31. FIG. 11 illustrates a plan view of the third circuit board 31c from the −Z direction. FIG. 11 illustrates a first surface S1 of the third circuit board 31c. FIG. 11 virtually shows the first fixation member 51, the second fixation member 53, a third fixation member 57, and a fourth fixation member 59.

Three inertial sensors 100 are placed on the third circuit board 31c. The three inertial sensors 100 are the first inertial sensor 101, the second inertial sensor 102, and the third inertial sensor 103. The first inertial sensor 101 and the second inertial sensor 102 are disposed at positions across the first fixation member 51 and the second fixation member 53 along the X axis. The first inertial sensor 101 and the third inertial sensor 103 are disposed at positions across the third fixation member 57 and the fourth fixation member 59 along the X axis. The first inertial sensor 101, the second inertial sensor 102, and the third inertial sensor 103 are disposed in the order of the third inertial sensor 103, the first inertial sensor 101, and the second inertial sensor 102 in the −X direction along the X axis.

The first inertial sensor 101, the second inertial sensor 102, and the third inertial sensor 103 provided to the third circuit board 31c are the same in configuration as the first inertial sensor 101, the second inertial sensor 102, and the third inertial sensor 103 provided to the first circuit board 31a.

The first fixation member 51 fixes the third circuit board 31c to the container 11 at an intermediate position along the X axis of the third circuit board 31c and at a position in the vicinity of an end portion at the −Y direction side of the third circuit board 31c. When the inertial measurement device 1 includes the third circuit board 31c, the container 11 is provided with a pedestal at a position where the first fixation member 51 is disposed. The pedestal is not illustrated. The first fixation member 51 fixes the third circuit board 31c to the pedestal of the container 11.

The first fixation member 51 is disposed between the first inertial sensor 101 and the second inertial sensor 102 along the X axis. The first inertial sensor 101, the first fixation member 51, and the second inertial sensor 102 are disposed in the order of the first inertial sensor 101, the first fixation member 51, and the second inertial sensor 102 in the −X direction along the X axis.

The second fixation member 53 fixes the third circuit board 31c to the container 11 at a position at the +Y direction side of the first fixation member 51, and in the vicinity of an end portion at the +Y direction side of the third circuit board 31c. When the inertial measurement device 1 includes the third circuit board 31c, the container 11 is provided with a pedestal at a position where the second fixation member 53 is disposed. The pedestal is not illustrated. The second fixation member 53 fixes the third circuit board 31c to the pedestal of the container 11.

The second fixation member 53 is disposed at the +Y direction side orthogonal to the X axis with respect to the first fixation member 51. The second fixation member 53 is disposed between the first inertial sensor 101 and the second inertial sensor 102 along the X axis. The second fixation member 53 may be disposed at a position at a crossing direction side with respect to the X axis from the first fixation member 51 as long as the second fixation member 53 is disposed between the first inertial sensor 101 and the second inertial sensor 102 along the X axis.

The third fixation member 57 fixes the third circuit board 31c to the first pedestal 11e of the container 11 at an intermediate position along the X axis of the third circuit board 31c and at a position in the vicinity of the end portion at the −Y direction side of the third circuit board 31c.

The third fixation member 57 is disposed between the first inertial sensor 101 and the third inertial sensor 103 along the X axis. The first inertial sensor 101, the third fixation member 57, and the third inertial sensor 103 are disposed in the order of the third inertial sensor 103, the third fixation member 57, and the first inertial sensor 101 in the −X direction along the X axis.

The fourth fixation member 59 fixes the third circuit board 31c to the second pedestal 11f of the container 11 at the +Y direction side of the third fixation member 57, and at a position in the vicinity of an end portion at the +Y direction side of the third circuit board 31c.

The fourth fixation member 59 is disposed at the +Y direction side orthogonal to the X axis with respect to the third fixation member 57. The fourth fixation member 59 is disposed between the first inertial sensor 101 and the third inertial sensor 103 along the X axis. The fourth fixation member 59 may be disposed at a position at a crossing direction side with respect to the X axis from the third fixation member 57 as long as the fourth fixation member 59 is disposed between the first inertial sensor 101 and the third inertial sensor 103 along the X axis. When the direction from the first fixation member 51 toward the second fixation member 53 is parallel to a direction from the third fixation member 57 toward the fourth fixation member 59, the size of the third circuit board 31c can be reduced.

The first inertial sensor 101 and the second inertial sensor 102 are disposed at positions across an area between the first fixation member 51 and the second fixation member 53 when viewed in a direction along the Z axis. By disposing the first fixation member 51 and the second fixation member 53 between the first inertial sensor 101 and the second inertial sensor 102, the interference between the natural frequencies of the first inertial sensor 101 and the second inertial sensor 102 in which the vibrator elements 270 vibrate in respective directions different from each other is suppressed. Thus, pairing of the first inertial sensor 101 and the second inertial sensor 102 becomes easy or unnecessary.

The first inertial sensor 101 and the third inertial sensor 103 are disposed at positions across an area between the third fixation member 57 and the fourth fixation member 59 when viewed in a direction along the Z axis. By disposing the third fixation member 57 and the fourth fixation member 59 between the first inertial sensor 101 and the third inertial sensor 103, the interference between the natural frequencies of the first inertial sensor 101 and the third inertial sensor 103 is suppressed. Thus, pairing between the first inertial sensor 101 and the third inertial sensor 103 becomes easy or unnecessary.

The first inertial sensor 101, the second inertial sensor 102, and the third inertial sensor 103 are disposed at positions across an area between the pair of fixation members, respectively. In each of the first inertial sensor 101, the second inertial sensor 102, and the third inertial sensor 103, the interference with the natural frequencies of the other inertial sensors 100 is suppressed. Thus, pairing among the first inertial sensor 101, the second inertial sensor 102, and the third inertial sensor 103 becomes easy or unnecessary.

The third circuit board 31c illustrated in FIG. 11 includes the three inertial sensors 100, but this is not a limitation. The third circuit board 31c may include the fourth inertial sensor 104, the fifth inertial sensor 105, and the sixth inertial sensor 106. In this case, the fourth inertial sensor 104 is disposed so as to be opposed to the first inertial sensor 101 across the third circuit board 31c. The fourth inertial sensor 104 is disposed on a second surface S2 of the third circuit board 31c. The fourth inertial sensor 104 is disposed at a position between the first fixation member 51 and the third fixation member 57 along the X axis. The fifth inertial sensor 105 faces the second inertial sensor 102 along the Y axis. The fifth inertial sensor 105 is disposed at a position at the −X direction side with respect to the first fixation member 51 and the second fixation member 53. The sixth inertial sensor 106 faces the third inertial sensor 103 along the X axis. The sixth inertial sensor 106 is disposed at a position at the +X direction side with respect to the third fixation member 57 and the fourth fixation member 59.

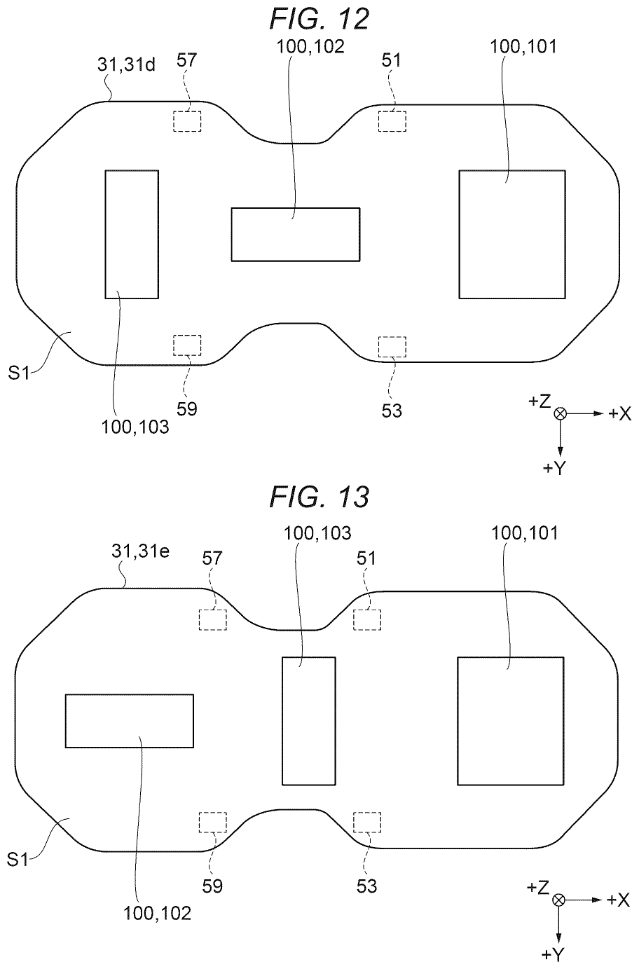

FIG. 12 illustrates a schematic configuration of a fourth circuit board 31d as an example of the circuit board 31. FIG. 12 illustrates a plan view of the fourth circuit board 31d from the −Z direction. FIG. 12 illustrates a first surface S1 of the fourth circuit board 31d. FIG. 12 virtually shows the first fixation member 51, the second fixation member 53, the third fixation member 57, and the fourth fixation member 59.

Three inertial sensors 100 are mounted on the fourth circuit board 31d. The three inertial sensors 100 are the first inertial sensor 101, the second inertial sensor 102, and the third inertial sensor 103. The first inertial sensor 101 and the second inertial sensor 102 are disposed at positions across the first fixation member 51 and the second fixation member 53 along the X axis. The second inertial sensor 102 and the third inertial sensor 103 are disposed at positions across the third fixation member 57 and the fourth fixation member 59 along the X axis. The first inertial sensor 101, the second inertial sensor 102, and the third inertial sensor 103 are disposed in the order of the first inertial sensor 101, the second inertial sensor 102, and the third inertial sensor 103 in the −X direction along the X axis.

The first t inertial sensor 101, the second inertial sensor 102, and the third inertial sensor 103 provided to the fourth circuit board 31d are the same in configuration as the first inertial sensor 101, the second inertial sensor 102, and the third inertial sensor 103 provided to the first circuit board 31a.

The first fixation member 51 fixes the fourth circuit board 31d to the first pedestal 11e of the container 11 at an intermediate position along the X axis of the fourth circuit board 31d and at a position in the vicinity of an end portion at the −Y direction side of the fourth circuit board 31d.

The first fixation member 51 is disposed between the first inertial sensor 101 and the second inertial sensor 102 along the X axis. The first inertial sensor 101, the first fixation member 51, and the second inertial sensor 102 are disposed in the order of the first inertial sensor 101, the first fixation member 51, and the second inertial sensor 102 in the −X direction along the X axis.

The second fixation member 53 fixes the fourth circuit board 31d to the second pedestal 11f of the container 11 at the +Y direction side of the first fixation member 51, and at a position in the vicinity of an end portion at the +Y direction side of the fourth circuit board 31d.

The second fixation member 53 is disposed at the +Y direction side orthogonal to the X axis with respect to the first fixation member 51. The second fixation member 53 is disposed between the first inertial sensor 101 and the second inertial sensor 102 along the X axis. The second fixation member 53 may be disposed at a position at a crossing direction side with respect to the X axis from the first fixation member 51 as long as the second fixation member 53 is disposed between the first inertial sensor 101 and the second inertial sensor 102 along the X axis.

The third fixation member 57 fixes the fourth circuit board 31d to the container 11 at an intermediate position along the X axis of the fourth circuit board 31d and at a position in the vicinity of the end portion at the −Y direction side of the fourth circuit board 31d. When the inertial measurement device 1 includes the fourth circuit board 31d, a pedestal is provided to the container 11 at a position where the third fixation member 57 is disposed. The pedestal is not illustrated. The third fixation member 57 fixes the fourth circuit board 31d to the pedestal of the container 11.

The third fixation member 57 is disposed between the second inertial sensor 102 and the third inertial sensor 103 along the X axis. The second inertial sensor 102, the third fixation member 57, and the third inertial sensor 103 are disposed in the order of the second inertial sensor 102, the third fixation member 57, and the third inertial sensor 103 in the −X direction along the X axis.

The fourth fixation member 59 fixes the fourth circuit board 31d to the container 11 at the +Y direction side of the third fixation member 57, and at a position in the vicinity of the end portion at the +Y direction side of the fourth circuit board 31d. When the inertial measurement device 1 includes the fourth circuit board 31d, a pedestal is provided to the container 11 at a position where the fourth fixation member 59 is disposed. The pedestal is not illustrated. The fourth fixation member 59 fixes the fourth circuit board 31d to the pedestal of the container 11.

The fourth fixation member 59 is disposed at the +Y direction side orthogonal to the X axis with respect to the third fixation member 57. The fourth fixation member 59 is disposed between the second inertial sensor 102 and the third inertial sensor 103 along the X axis. The fourth fixation member 59 may be disposed at a position at a crossing direction side with respect to the X axis from the third fixation member 57 as long as the fourth fixation member 59 is disposed between the second inertial sensor 102 and the third inertial sensor 103 along the X axis. When the direction from the first fixation member 51 toward the second fixation member 53 is parallel to a direction from the third fixation member 57 toward the fourth fixation member 59, the size of the fourth circuit board 31d can be reduced.

The first inertial sensor 101 and the second inertial sensor 102 are disposed at positions across an area between the first fixation member 51 and the second fixation member 53 when viewed in a direction along the Z axis. By disposing the first fixation member 51 and the second fixation member 53 between the first inertial sensor 101 and the second inertial sensor 102, the interference between the natural frequencies of the first inertial sensor 101 and the second inertial sensor 102 in which the vibrator elements 270 vibrate in respective directions different from each other is suppressed. Thus, pairing of the first inertial sensor 101 and the second inertial sensor 102 becomes easy or unnecessary.

The second inertial sensor 102 and the third inertial sensor 103 are disposed at positions across an area between the third fixation member 57 and the fourth fixation member 59 when viewed in a direction along the Z axis. By disposing the third fixation member 57 and the fourth fixation member 59 between the second inertial sensor 102 and the third inertial sensor 103, the interference between the natural frequencies of the second inertial sensor 102 and the third inertial sensor 103 is suppressed. Thus, pairing of the second inertial sensor 102 and the third inertial sensor 103 becomes easy or unnecessary.

The first inertial sensor 101, the second inertial sensor 102, and the third inertial sensor 103 are disposed at positions across an area between the pair of fixation members, respectively. In each of the first inertial sensor 101, the second inertial sensor 102, and the third inertial sensor 103, the interference with the natural frequencies of the other inertial sensors 100 is suppressed. Thus, pairing among the first inertial sensor 101, the second inertial sensor 102, and the third inertial sensor 103 becomes easy or unnecessary.

The fourth circuit board 31d illustrated in FIG. 12 includes the three inertial sensors 100, but this is not a limitation. The fourth circuit board 31d may include the fourth inertial sensor 104, the fifth inertial sensor 105, and the sixth inertial sensor 106. In this case, the fourth inertial sensor 104 is disposed so as to be opposed to the first inertial sensor 101 across the fourth circuit board 31d. The fourth inertial sensor 104 is disposed on a second surface S2 of the fourth circuit board 31d. The fourth inertial sensor 104 is disposed at a position at the +X direction side with respect to the first fixation member 51 and the second fixation member 53 along the X axis. The fifth inertial sensor 105 faces the second inertial sensor 102 along the Y axis. The fifth inertial sensor 105 is disposed at a position between the first fixation member 51 and the third fixation member 57 along the X axis. The sixth inertial sensor 106 faces the third inertial sensor 103 along the X axis. The sixth inertial sensor 106 is disposed at a position at the −X direction side with respect to the third fixation member 57 and the fourth fixation member 59.

FIG. 13 illustrates a schematic configuration of a fifth circuit board 31e as an example of the circuit board 31. FIG. 13 illustrates a plan view of the fifth circuit board 31e from the −Z direction. FIG. 1 illustrates a first surface S1 of the fifth circuit board 31e. FIG. 13 virtually shows the first fixation member 51, the second fixation member 53, the third fixation member 57, and the fourth fixation member 59.

Three inertial sensors 100 are mounted on the fifth circuit board 31e. The three inertial sensors 100 are the first inertial sensor 101, the second inertial sensor 102, and the third inertial sensor 103. The first inertial sensor 101 and the third inertial sensor 103 are disposed at positions across the first fixation member 51 and the second fixation member 53 along the X axis. The second inertial sensor 102 and the third inertial sensor 103 are disposed at positions across the third fixation member 57 and the fourth fixation member 59 along the X axis. The first inertial sensor 101, the second inertial sensor 102, and the third inertial sensor 103 are disposed in the order of the first inertial sensor 101, the third inertial sensor 103, and the second inertial sensor 102 in the −X direction along the X axis.

The first inertial sensor 101, the second inertial sensor 102, and the third inertial sensor 103 provided to the fifth circuit board 31e are the same in configuration as the first inertial sensor 101, the second inertial sensor 102, and the third inertial sensor 103 provided to the first circuit board 31a.

The first fixation member 51 fixes the fifth circuit board 31e to the first pedestal 11e of the container 11 at an intermediate position along the X axis of the fifth circuit board 31e and at a position in the vicinity of an end portion at the −Y direction side of the fifth circuit board 31e.

The first fixation member 51 is disposed between the first inertial sensor 101 and the third inertial sensor 103 along the X axis. The first inertial sensor 101, the first fixation member 51, and the third inertial sensor 103 are disposed in the order of the first inertial sensor 101, the first fixation member 51, and the third inertial sensor 103 in the −X direction along the X axis.

The second fixation member 53 fixes the fifth circuit board 31e to the second pedestal 11f of the container 11 at the +Y direction side of the first fixation member 51, and at a position in the vicinity of an end portion at the +Y direction side of the fifth circuit board 31e.

The second fixation member 53 is disposed at the +Y direction side orthogonal to the X axis with respect to the first fixation member 51. The second fixation member 53 is disposed between the first inertial sensor 101 and the third inertial sensor 103 along the X axis. The second fixation member 53 may be disposed at a position at a crossing direction side with respect to the X axis from the first fixation member 51 as long as the second fixation member 53 is disposed between the first inertial sensor 101 and the third inertial sensor 103 along the X axis.

The third fixation member 57 fixes the fifth circuit board 31e to the container 11 at an intermediate position along the X axis of the fifth circuit board 31e and at a position in the vicinity of the end portion at the −Y direction side of the fifth circuit board 31e. When the inertial measurement device 1 includes the fifth circuit board 31e, a pedestal is provided to the container 11 at a position where the third fixation member 57 is disposed. The pedestal is not illustrated. The third fixation member 57 fixes the fifth circuit board 31e to the pedestal of the container 11.

The third fixation member 57 is disposed between the second inertial sensor 102 and the third inertial sensor 103 along the X axis. The second inertial sensor 102, the third fixation member 57, and the third inertial sensor 103 are disposed in the order of the third inertial sensor 103, the third fixation member 57, and the second inertial sensor 102 in the −X direction along the X axis.

The fourth fixation member 59 fixes the fifth circuit board 31e to the container 11 at the +Y direction side of the third fixation member 57, and at a position in the vicinity of the end portion at the +Y direction side of the fifth circuit board 31e. When the inertial measurement device 1 includes the fifth circuit board 31e, the container 11 is provided with a pedestal at a position where the fourth fixation member 59 is disposed. The pedestal is not illustrated. The fourth fixation member 59 fixes the fifth circuit board 31e to the pedestal of the container 11.

The fourth fixation member 59 is disposed at the +Y direction side orthogonal to the X axis with respect to the third fixation member 57. The fourth fixation member 59 is disposed between the second inertial sensor 102 and the third inertial sensor 103 along the X axis. The fourth fixation member 59 may be disposed at a position at a crossing direction side with respect to the X axis from the third fixation member 57 as long as the fourth fixation member 59 is disposed between the second inertial sensor 102 and the third inertial sensor 103 along the X axis. When the direction from the first fixation member 51 toward the second fixation member 53 is parallel to a direction from the third fixation member 57 toward the fourth fixation member 59, the size of the fifth circuit board 31e can be reduced.

The first inertial sensor 101 and the third inertial sensor 103 are disposed at positions across an area between the first fixation member 51 and the second fixation member 53 when viewed in a direction along the Z axis. By disposing the first fixation member 51 and the second fixation member 53 between the first inertial sensor 101 and the third inertial sensor 103, the interference between the natural frequencies of the first inertial sensor 101 and the third inertial sensor 103 is suppressed. Thus, pairing between the first inertial sensor 101 and the third inertial sensor 103 becomes easy or unnecessary.

The second inertial sensor 102 and the third inertial sensor 103 are disposed at positions across an area between the third fixation member 57 and the fourth fixation member 59 when viewed in a direction along the Z axis. By disposing the third fixation member 57 and the fourth fixation member 59 between the second inertial sensor 102 and the third inertial sensor 103, the interference between the natural frequencies of the second inertial sensor 102 and the third inertial sensor 103 is suppressed. Thus, pairing of the second inertial sensor 102 and the third inertial sensor 103 becomes easy or unnecessary.

The first inertial sensor 101, the second inertial sensor 102, and the third inertial sensor 103 are disposed at positions across an area between the pair of fixation members, respectively. In each of the first inertial sensor 101, the second inertial sensor 102, and the third inertial sensor 103, the interference with the natural frequencies of the other inertial sensors 100 is suppressed. Thus, pairing among the first inertial sensor 101, the second inertial sensor 102, and the third inertial sensor 103 becomes easy or unnecessary.

The fifth circuit board 31e illustrated in FIG. 13 includes the three inertial sensors 100, but this is not a limitation. The fifth circuit board 31e may include the fourth inertial sensor 104, the fifth inertial sensor 105, and the sixth inertial sensor 106. In this case, the fourth inertial sensor 104 is disposed so as to be opposed to the first inertial sensor 101 across the fifth circuit board 31e. The fourth inertial sensor 104 is disposed on a second surface S2 of the fifth circuit board 31e. The fourth inertial sensor 104 is disposed at a position at the +X direction side with respect to the first fixation member 51 and the second fixation member 53 along the X axis. The fifth inertial sensor 105 faces the second inertial sensor 102 along the Y axis. The fifth inertial sensor 105 is disposed at a position at the −X direction side with respect to the third fixation member 57 and the fourth fixation member 59. The sixth inertial sensor 106 faces the third inertial sensor 103 along the X axis. The sixth inertial sensor 106 is disposed at a position between the first fixation member 51 and the third fixation member 57.

What is claimed is:

1. An inertial measurement device comprising:
a substrate;
a container configured to house the substrate;
a first fixation member and a second fixation member each configured to fix the substrate to the container;
a first sensor disposed at the substrate and configured to detect a physical quantity along an orthogonal axis to the substrate; and
a second sensor disposed at the substrate, wherein
the first sensor, the first fixation member and the second fixation member, and the second sensor are arranged in this order in a first direction along a first axis parallel to the substrate,
the second sensor detects a physical quantity along a second axis parallel to the substrate and orthogonal to the first axis, and
the second sensor is separated from the first sensor by an area between the first fixation member and the second fixation member when viewed in a direction along the orthogonal axis.

2. The inertial measurement device according to claim 1, further comprising:
a third sensor disposed at the substrate and configured to detect a physical quantity along the first axis.

3. The inertial measurement device according to claim 2, further comprising:
a third fixation member and a fourth fixation member each configured to fix the substrate to the container, wherein
the third sensor, the third fixation member and the fourth fixation member, and the first sensor are arranged in this order in the first direction, and
the third sensor is separated from the first sensor by an area between the third fixation member and the fourth fixation member when viewed in the direction along the orthogonal axis.

4. The inertial measurement device according to claim 2, further comprising:
a third fixation member and a fourth fixation member each configured to fix the substrate to the container, wherein
the second sensor, the third fixation member and the fourth fixation member, and the third sensor are arranged in this order in the first direction, and
the third sensor is separated from the second sensor by an area between the third fixation member and the fourth fixation member when viewed in the direction along the orthogonal axis.

5. The inertial measurement device according to claim 3, wherein
a direction from the third fixation member toward the fourth fixation member is parallel to a direction from the first fixation member toward the second fixation member.

6. The inertial measurement device according to claim 4, wherein
a direction from the third fixation member toward the fourth fixation member is parallel to a direction from the first fixation member toward the second fixation member.

7. The inertial measurement device according to claim 2, wherein
the third sensor is disposed at the area between the first fixation member and the second fixation member when viewed in the direction along the orthogonal axis.

8. The inertial measurement device according to claim 2, further comprising:
a fourth sensor disposed at the substrate so as to be opposed to the first sensor across the substrate and configured to detect the physical quantity along the orthogonal axis;
a fifth sensor disposed at the substrate so as to face the second sensor and configured to detect the physical quantity along the second axis; and
a sixth sensor disposed at the substrate so as to face the third sensor and configured to detect the physical quantity along the first axis.
